(19) United States
(12) Patent Application Publication
(10) Pub. No.: US 2018/0121044 A1
(43) Pub. Date: May 3, 2018

(54) RUN-TIME EVENT HANDLER GENERATION IN JSON ENVIRONMENTS

(71) Applicants: Amber Joy Watkins, Longmont, CO (US); Marquis G. Waller, Beverly, OH (US); Razvan Placintar, Timisoara (RO)

(72) Inventors: Amber Joy Watkins, Longmont, CO (US); Marquis G. Waller, Beverly, OH (US); Razvan Placintar, Timisoara (RO)

(73) Assignee: Ricoh Company, Ltd., Tokyo (JP)

(21) Appl. No.: 15/336,659

(22) Filed: Oct. 27, 2016

(51) Int. Cl. G06F 3/0484; G06F 9/44

(52) U.S. Cl. CPC G06F 3/0484; G06F 8/315; G06F 8/38

(57) ABSTRACT

Systems and methods are provided for generating event handlers on-the-fly in a JavaScript Object Notation (JSON) environment. One embodiment is a system that includes a memory storing multiple JSON files. Each JSON file stores JSON objects that each define controls of a Graphical User Interface (GUI). The system also includes a controller that loads a primary JSON file from the memory, generates a GUI including controls defined by the primary JSON file, transmits instructions to a display to present the GUI to a user, and detects input from a user interface indicating user interaction with one of the controls. In response to the input, the controller loads a JSON extension file defining additional controls for the GUI, populates the GUI with the additional controls, analyzes the JSON extension file to determine event handlers defined for the additional controls, and sets up the event handlers for the additional controls. The controller also detects additional user input pertaining to the additional controls via the event handlers, and performs an action at the GUI indicated by the triggered event handler.

### FIELD OF THE INVENTION

The invention relates to the field of Graphical User Interfaces (GUIs), and in particular, to GUIs that are built using JavaScript Object Notation (JSON).

### BACKGROUND

GUIs provide an opportunity for a user of a computer system to interact with application-layer programs that govern the operations of the computer system. For example, a GUI may be provided by a print server via a website in order to enable a user to control how print jobs are stored, queued, and printed at a print shop.

JavaScript may be used to program a GUI for an application. In such circumstances, JSON may be utilized to define each of multiple interactive elements (known as “controls”) within the GUI. A designer of a GUI may desire that the GUI be implemented in a customizable manner such that different controls appear on the GUI when a user interacts with the GUI in different ways. For example, this may include dynamically presenting one set of controls to manage a printer via the GUI, and another presenting set of controls to modify a print job. However, such processes normally require that each control be hard-coded into a design of the GUI and integrated into a single file defining the GUI. This presents an issue in that third parties may desire to provide extensions to the GUI that alter or enhance the sets of controls that are available. If the controls for a GUI are hard-coded, it may be impossible to dynamically extend or alter the contents of the GUI. In many cases, this is infeasible.

Thus, designers of GUIs continue to seek out enhanced techniques that provide for flexibility in the design and usage of GUIs.

### SUMMARY

Embodiments described herein dynamically create and utilize event handlers at a GUI in order to alter the composition of the GUI. The event handlers listen for specific events relating to user actions at a GUI. When a user performs specific actions at the GUI, the event handlers retrieve additional JSON configuration files that define new controls to display on the GUI. The additional JSON configuration files also define new event handlers for those new controls. This enables the GUI to dynamically scale in size and complexity as the GUI is actively being used.

One embodiment is a system that includes a memory storing multiple JSON files. Each JSON file stores JSON objects that each define controls of a Graphical User Interface (GUI). The system also includes a controller that loads a primary JSON file from the memory, generates a GUI including controls defined by the primary JSON file, transmits instructions to a display to present the GUI to a user, and detects input from a user interface indicating user interaction with one of the controls. In response to the input, the controller loads a JSON extension file defining additional controls for the GUI, populates the GUI with the additional controls, analyzes the JSON extension file to determine event handlers defined for the additional controls, and sets up the event handlers for the additional controls. The controller also detects additional user input pertaining to the additional controls via the event handlers, and performs an action at the GUI indicated by the triggered event handler.

Other exemplary embodiments (e.g., methods and computer-readable media relating to the foregoing embodiments) may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 is a block diagram of a GUI system in an exemplary embodiment.

FIG. 2 is a flowchart illustrating a method for generating a GUI in an exemplary embodiment.

FIG. 3 is a message diagram illustrating additional details of operations of a GUI system in an exemplary embodiment.

FIG. 4 illustrates a GUI that has been dynamically generated in an exemplary embodiment.

FIG. 5 is a diagram illustrating an exemplary primary JSON configuration file in an exemplary embodiment.

FIG. 6 is a diagram illustrating an exemplary additional JSON configuration file in an exemplary embodiment.

FIG. 7 illustrates a processing system operable to execute a computer readable medium embodying programmed instructions to perform desired functions in an exemplary embodiment.

### DETAILED DESCRIPTION

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

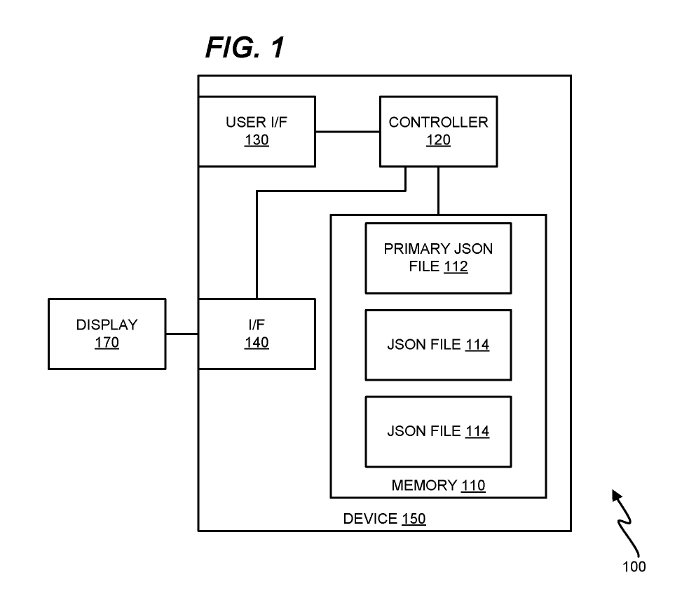

FIG. 1 is a block diagram of a GUI system 100 in an exemplary embodiment. GUI system 100 comprises any system, device, or component operable to present a GUI to a user in order to enable the user to interact with an electronic device. In this embodiment, GUI system 100 comprises device 150 and display 170. Device 150 may comprise a print server, a printer, a general-purpose server, etc. Device 150 includes memory 110, controller 120, user interface (I/F) 130, and I/F 140.

Memory 110 stores a primary JSON file 112 that defines a GUI for interacting with applications on device 150. File 112 is formatted in accordance with JSON standards, and defines the appearance and layout of the GUI when the GUI is initially presented to a user. JSON standards are described, for example, in the JSON Data Interchange Format, ECMA-404 (1^{st} Edition, October 2013), issued by ECMA international. Memory 110 also stores JSON files 114. Files 114 are JSON “extensions” that store additional content which is dynamically loaded at the GUI in response to the user interacting with the GUI in a predefined manner. For example, a JSON file 114 may be loaded to add controls to the GUI, in response to the user clicking on a specific control that is already presented on the GUI. Files 114 may be generated by a third party to enhance the capabilities or versatility of the GUI.

Controller 120 manages the general operations of device 150 as device 150 generates, updates, and revises the GUI. Controller 120 transmits instructions to display 170 via I/F 140 (e.g., an Ethernet interface or other data interface). Controller 120 receives input via user I/F 130. Controller 120 may be implemented as custom circuitry, as a processor executing programmed instructions, etc. User I/F 130 may comprise, for example, a keyboard, mouse, haptic touch interface, microphone, etc. User I/F 130 provides input to controller 120 indicating the actions of a user with respect to the generated GUI. This means that user I/F 130 may provide input indicating which GUI controls have been selected, what data the user has entered into a GUI control, etc.

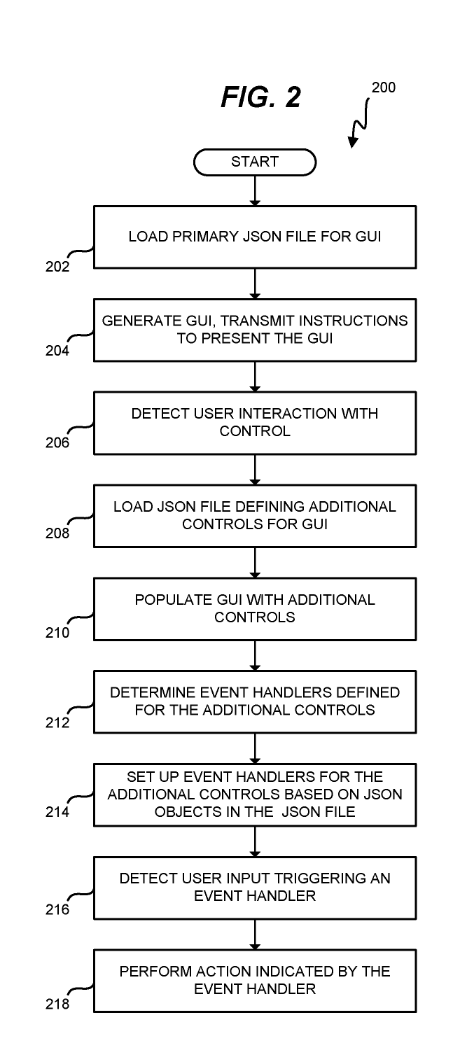

The particular arrangement, number, and configuration of components described herein is exemplary and non-limiting. Illustrative details of the operation of GUI system 100 will be discussed with regard to FIG. 2. Assume, for this embodiment, that device 150 has initiated an application that utilizes a GUI. For example, an Operating System (OS) of device 150 may load an application for interacting with a printer or print server. The application includes one or more GUIs for a user to provide input to device 150 in order to direct the operations of the application.

FIG. 2 is a flowchart illustrating a method 200 for generating a GUI in an exemplary embodiment. The steps of method 200 are described with reference to GUI system 100 of FIG. 1, but those skilled in the art will appreciate that method 200 may be performed in other systems. The steps of the flowcharts described herein are not all inclusive and may include other steps not shown. The steps described herein may also be performed in an alternative order.

A user desires to interact with an application operating on device 150, and therefore triggers a request (via user I/F 130) to generate a GUI. Controller 120 loads primary JSON configuration file 112 in response to the request (step 202). Controller 120 creates instructions for generating the GUI (e.g., as a JavaScript GUI) based on the contents of file 112. This process may involve reviewing individual JSON objects within file 112. For each JSON object, controller 120 may generate a control, label, or field defined by that JSON object. As used herein, a control is an interactive element of a GUI capable of receiving user input. A label is statically defined data, and a field displays data at device 150 that may change over time. Controller 120 further transmits the instructions to display 170 in order to present the GUI to the user (step 204).

With the GUI presented to the user via display 170, controller 120 awaits user input provided via user I/F 130. The input may be detected, for example, by preparing an event handler for each control presented via display 170. Input on user I/F 130 is then monitored. In this manner, if an event handler is triggered, controller 120 determines that the user has interacted with a control corresponding to that event handler.

Controller 120 detects user interaction with a control based on input from user I/F 130 (step 206). This may be performed for example, by receiving input from an event handler indicating that the control has been clicked upon. In response to detecting user interaction with the control on the GUI, controller 120 analyzes memory 110 to detect a JSON file 114 that corresponds with the control. For example, the event handler that detected the user interacting with the control may be correlated with a specific JSON file 114. Controller 120 may therefore load the JSON file 114 in response to the user clicking on that control (step 208). At this juncture, it is relevant to note that file 112 need not necessarily be distinguished from file 114 by the inclusion of special formats or commands. In one embodiment, file 112 is different from files 114 only in that file 112 includes instructions for generating the first set of controls for interaction at the GUI.

File 114 defines additional controls for the GUI, including a layout indicating where to place each of the additional controls on the GUI. Controller 120 therefore populates the GUI with the additional controls (step 210). Furthermore, file 114 provides JSON objects that define new event handlers to set up for the GUI. Each new event handler may correspond with a control defined in file 114. Controller 120 analyzes the JSON objects in file 114 to determine event handlers defined for the additional controls (step 212). Specifically, controller 120 reads a configuration section at file 114 to construct the event handlers. Controller 120 also sets up event handlers for the additional controls for the GUI (step 214). The JSON objects also indicate what actions to perform if one of the new event handlers is triggered. In this manner, new controls that are added may have event handlers created for them in order for controller 120 to monitor and react to new interactions from a user (e.g., by setting up subroutines that monitor user I/F 130).

Controller 120 eventually detects user input that triggers an event handler monitoring one of the additional controls defined in file 114 (step 216). The event may comprise a user selecting, editing, or otherwise interacting with one of the additional controls in a manner that is detected by a newly set up event handler. In response to detecting the event, controller 120 proceeds to perform an action indicated by that event handler (step 218). This action may comprise loading another JSON file 114, updating information in the GUI, etc.

Method 200 provides a substantial benefit over prior JSON GUIs, in that the GUI of method 200 is dynamically generated and hence occupies a small footprint in memory 110. Certain controls within the GUI do not exist (and hence do not need to be monitored for events) until the user interacts with the GUI in a specific manner. Hence, the GUI takes up less space in primary memory than monolithic GUI systems. Furthermore, since the GUI is generated from discrete JSON files, developers who desire to add functionality to the GUI may do so in a compartmentalized space which is segregated from other JSON files defining other aspects of the GUI.

In a further embodiment, primary JSON file 112 (i.e., the first JSON file loaded by controller 120) includes instructions for setting up event handlers in a similar manner to JSON files 114. This means that primary JSON file 112 is distinguished from JSON files 114 only in that JSON file 112 is the first JSON file loaded, and that each JSON file describes different controls for the GUI.

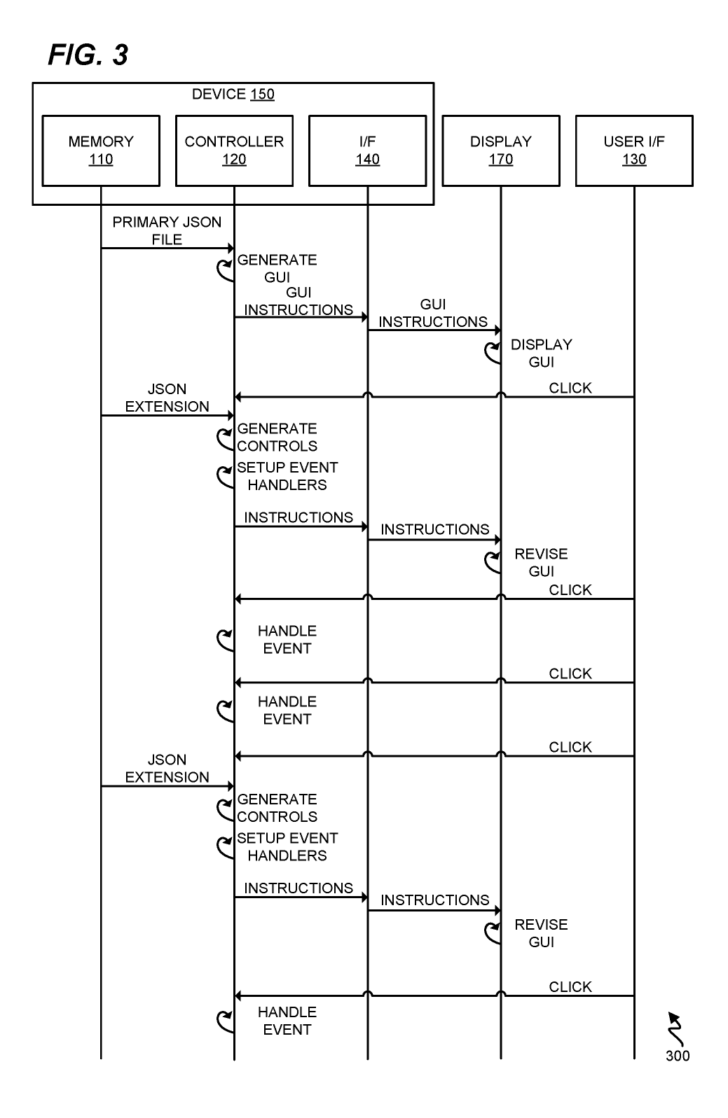

FIG. 3 is a message diagram 300 illustrating additional details of operations of a GUI system in an exemplary embodiment. Specifically, FIG. 3 illustrates that controller 120 loads a primary JSON file from memory 110. The primary JSON file includes instructions defining a location of each control on the GUI, and may further include instructions defining event handlers to monitor user interactions with each of the controls. Controller 120 generates instructions for presenting the GUI based on the primary JSON file, and display 170 presents the GUI. Then, as part of an ongoing process, controller 120 monitors user I/F 130 to detect user input relating to at least one event handler that has already been set up. If an event handler is triggered, controller 120 proceeds to load another JSON extension file corresponding to the event handler. The new JSON file includes its own list of new controls and event handlers. Controller 120 therefore directs display 170 to update the GUI in accordance with the JSON file. In this manner, new controls may be added to a GUI, and new event handlers may be created for those new controls. Controller 120 may then monitor the GUI in accordance with the new event handlers, and may further proceed to load more JSON extension files, depending on the user's interactions with the GUI. The GUI may continue to dynamically expand and alter in this manner.

### EXAMPLES

In the following examples, additional processes, systems, and methods are described in the context of a GUI system that generates and dynamically updates GUIs for a user in an exemplary embodiment.

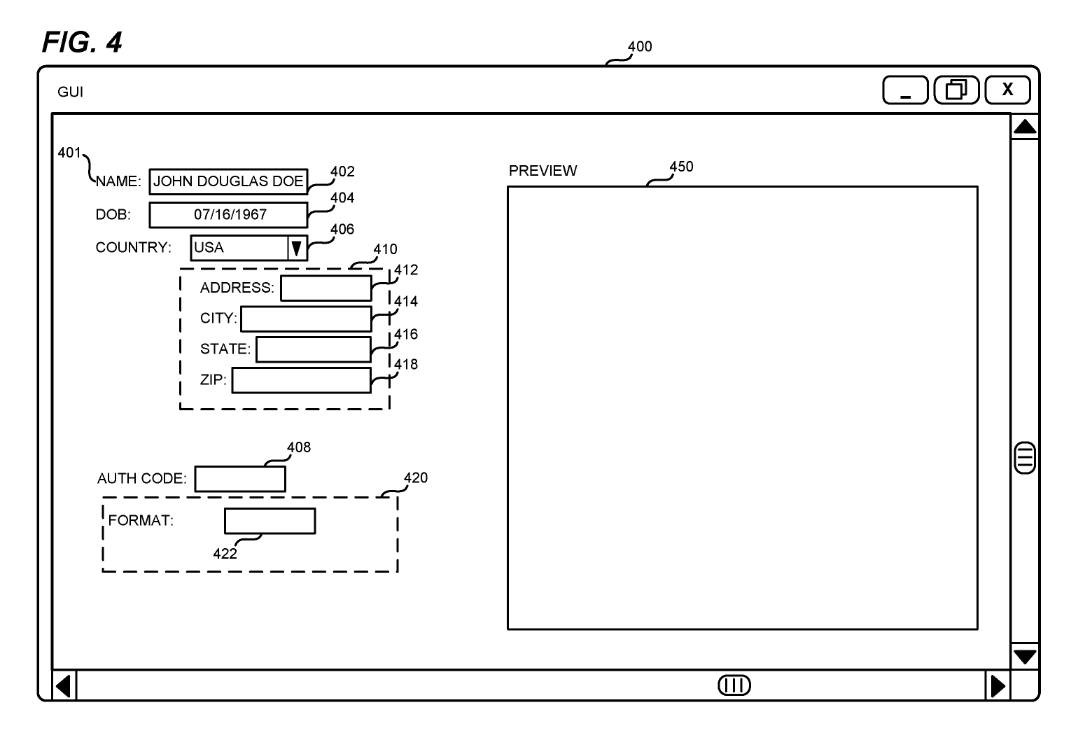

FIG. 4 illustrates a GUI 400 that has been dynamically generated in an exemplary embodiment. GUI 400 is implemented as a software window in this embodiment. According to FIG. 4, GUI 400 includes multiple labels such as label 401. The labels may present textual or visual information to a user in order to indicate the purpose of one or more controls on GUI 400. In this embodiment, multiple controls 402-406 are also presented in GUI 400. As used herein and discussed above, a control comprises a feature that a user may interact with in order to provide input to device 150. Controls 402-404 and 408 are illustrated as text boxes which a user may type into to provide textual input to device 150. Meanwhile, control 406 comprises a drop-down menu. Controls 402-408 are defined in a primary JSON file maintained in memory 110. Controls 412-418 are not defined in the primary JSON file. This means that controls 412-418 in regions 410 and 420 do not exist at the time that GUI 400 is created.

The primary JSON file also defines event handlers to set up for GUI 400. One event handler listens for a user selecting “USA” from control 406. If “USA” is selected, then the event handler directs controller 120 to load an extension JSON file. The extension JSON file defines four new controls 412, 414, 416, and 418. These controls are located in region 410. Each new control comprises a text box for entering data. Controls 412-418 do not exist prior to the user selecting “USA” in control 406, because the JSON objects defining these controls have not been loaded by controller 120. The JSON file defining controls 412-418 also includes JSON objects that define new event handlers. One of the new event handlers monitors control 418, relating to ZIP code. If the ZIP code is updated, the event handler directs controller 120 to update city and state in controls 414 and 416 to match the new ZIP code.

The primary JSON configuration file may further include an event handler that monitors control 408, which relates to authorization. In this example, if an authorization code entered at control 408 corresponds with a predefined value (e.g., a password), then a second JSON file is loaded. This second JSON file defines a control 422 enabling a user to select an encoding scheme. The second JSON file also defines an event handler that monitors control 422. Whenever the user updates control 422 with information describing a new encoding scheme, controller 120 utilizes a new algorithm to preview a file shown in preview pane 450. Control 422, and its corresponding event handler, do not exist until the second JSON file is loaded. This ensures that GUI 400 does not occupy more space in memory than needed at any given point in time.

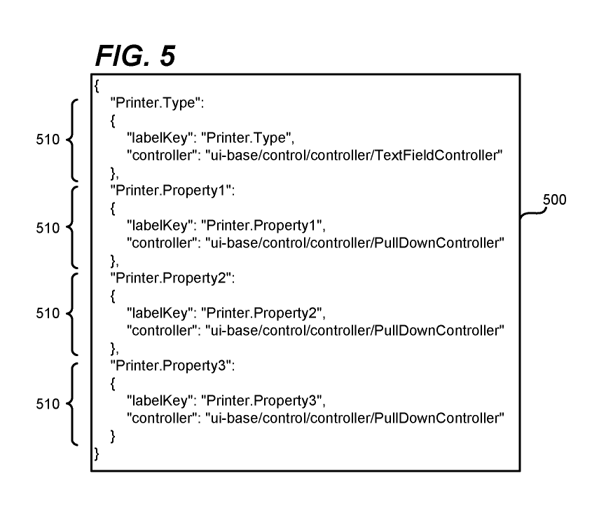

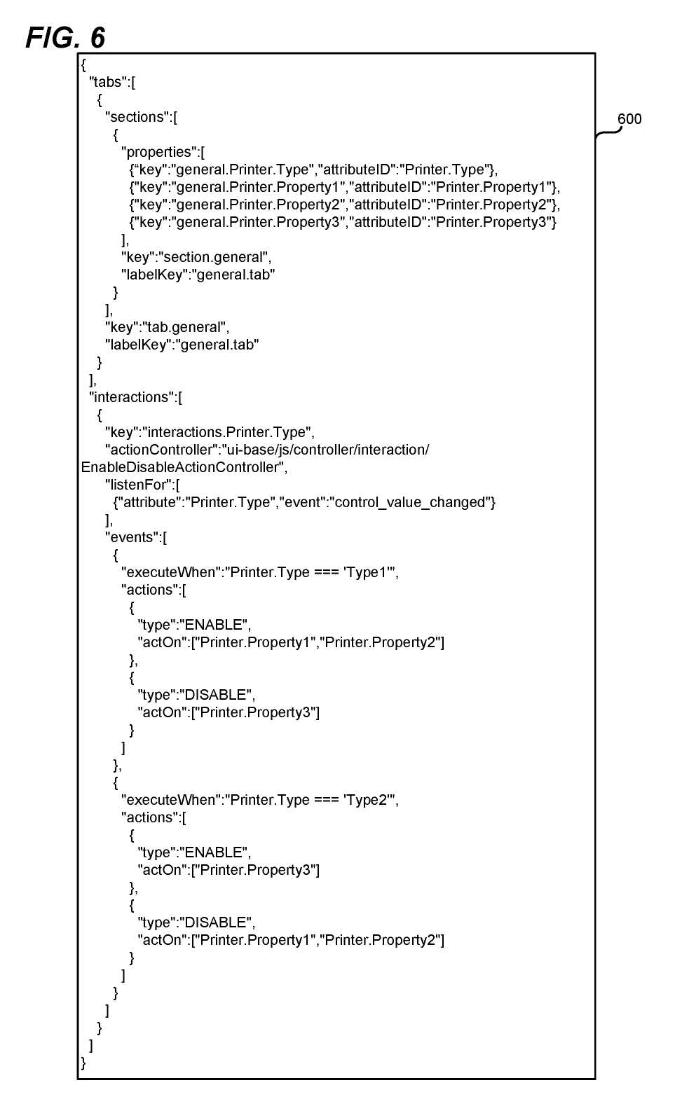

FIGS. 5-6 illustrate exemplary contents of a primary JSON file and extension JSON file, respectively. FIG. 5 is a diagram illustrating a primary JSON configuration file 500 in an exemplary embodiment. As illustrated in FIG. 5, file 500 includes a number of JSON objects 510 which define controls that enable a user to interact with a GUI. Each JSON object 510 is associated with a labelKey that uniquely identifies the JSON object (and corresponding control). Furthermore, each JSON object includes a property defining how the control is presented to a user (e.g., as a drop-down menu, fillable text box, etc.).

FIG. 6 is a diagram illustrating an extension JSON file 600 in an exemplary embodiment. According to FIG. 6, file 600 includes JSON objects. The JSON objects include custom JSON properties that define event handlers. In short, the custom JSON properties define how to set up event handlers for various controls on the GUI. The custom JSON properties include a custom JSON property indicating an event to listen for, and a custom JSON property indicating an action to perform in response to the event.

In this example, file 600 also defines actions to perform when event handlers detect specific events. In this embodiment, the actions enable or disable controls. The controls to be enabled or disabled are identified based on their labelKey. In this example, when the user sets a value for one control, the system determines whether or not other controls become enabled or disabled.

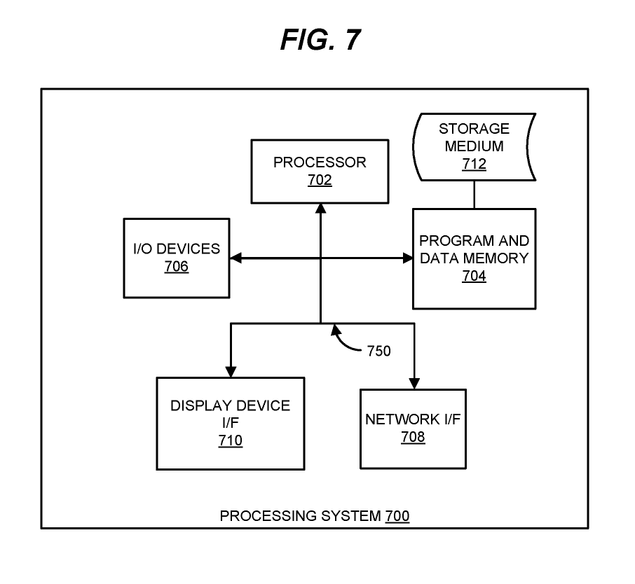

Embodiments disclosed herein can take the form of software, hardware, firmware, or various combinations thereof. In one particular embodiment, software is used to direct a processing system of GUI system 100 to perform the various operations disclosed herein. FIG. 7 illustrates a processing system 700 operable to execute a computer readable medium embodying programmed instructions to perform desired functions in an exemplary embodiment. Processing system 700 is operable to perform the above operations by executing programmed instructions tangibly embodied on computer readable storage medium 712. In this regard, embodiments of the invention can take the form of a computer program accessible via computer-readable medium 712 providing program code for use by a computer or any other instruction execution system. For the purposes of this description, computer readable storage medium 712 can be anything that can contain or store the program for use by the computer.

Computer readable storage medium 712 can be an electronic, magnetic, optical, electromagnetic, infrared, or semiconductor device. Examples of computer readable storage medium 712 include a solid state memory, a magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

Processing system 700, being suitable for storing and/or executing the program code, includes at least one processor 702 coupled to program and data memory 704 through a system bus 750. Program and data memory 704 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 706 (including but not limited to keyboards, displays, pointing devices, etc.) can be coupled either directly or through intervening I/O controllers. Network adapter interfaces 708 may also be integrated with the system to enable processing system 700 to become coupled to other data processing systems or storage devices through intervening private or public networks. Modems, cable modems, IBM Channel attachments, SCSI, Fibre Channel, and Ethernet cards are just a few of the currently available types of network or host interface adapters. Display device interface 710 may be integrated with the system to interface to one or more display devices, such as printing systems and screens for presentation of data generated by processor 702.

Although specific embodiments were described herein, the scope of the invention is not limited to those specific embodiments. The scope of the invention is defined by the following claims and any equivalents thereof.

We claim:

1. A system comprising:
a memory storing multiple JavaScript Object Notation (JSON) files, each JSON file storing JSON objects that each define controls of a Graphical User Interface (GUI); and
a controller that loads a primary JSON file from the memory, generates a GUI including controls defined by the primary JSON file, transmits instructions to a display to present the GUI to a user, and detects input from a user interface indicating user interaction with one of the controls,
in response to the input, the controller loads a JSON extension file defining additional controls for the GUI, populates the GUI with the additional controls, analyzes the JSON extension file to determine event handlers defined for the additional controls, and sets up the event handlers for the additional controls, and
the controller detects additional user input pertaining to the additional controls via the event handlers, and performs an action at the GUI indicated by the triggered event handler.

2. The system of claim 1 wherein:
each event handler is defined in the JSON extension file within a JSON object that includes custom JSON properties.

3. The system of claim 2 wherein:
the custom JSON properties include a custom JSON property indicating an event to listen for, and a custom JSON property indicating an action to perform in response to the event.

4. The system of claim 1 wherein:
the controller performs the action at the GUI by loading another JSON extension file defining further controls for the GUI.

5. The system of claim 1 wherein:
the controller implements the GUI as a JavaScript GUI.

6. The system of claim 1 wherein:
the controller sets up the event handlers by setting up subroutines that monitor input from a user interface.

7. The system of claim 1 wherein:
prior to loading the JSON extension file, the GUI does not include the additional controls.

8. A method comprising:
loading a primary JavaScript Object Notation (JSON) file from a memory that stores multiple JSON files, wherein each JSON file stores JSON objects that each define controls of a Graphical User Interface (GUI);
generating a GUI including controls defined by the primary JSON file;
transmitting instructions to a display to present the GUI to a user;
detecting input from a user interface indicating user interaction with one of the controls;
in response to the input:
loading a JSON extension file defining additional controls for the GUI;
populating the GUI with the additional controls;
analyzing the JSON extension file to determine event handlers defined for the additional controls; and
setting up the event handlers for the additional controls;
detecting additional user input triggering an event handler; and
performing an action at the GUI indicated by the triggered event handler.

9. The method of claim 8 wherein:
each event handler is defined in the JSON extension file within a JSON object that includes custom JSON properties.

10. The method of claim 9 wherein:
the custom JSON properties include a custom JSON property indicating an event to listen for, and a custom JSON property indicating an action to perform in response to the event.

11. The method of claim 8 wherein:
performing the action at the GUI comprises loading another JSON extension file defining further controls for the GUI.

12. The method of claim 8 wherein:
the GUI is implemented as a JavaScript GUI.

13. The method of claim 8 further comprising:
setting up the event handlers by setting up subroutines that monitor input from a user interface.

14. The method of claim 8 wherein:
prior to loading the JSON extension file, the GUI does not include the additional controls.

15. A non-transitory computer readable medium embodying programmed instructions which, when executed by a processor, are operable for performing a method comprising:
loading a primary JavaScript Object Notation (JSON) file from a memory that stores multiple JSON files, wherein each JSON file stores JSON objects that each define controls of a Graphical User Interface (GUI);
generating a GUI including controls defined by the primary JSON file;
transmitting instructions to a display to present the GUI to a user;
detecting input from a user interface indicating user interaction with one of the controls;
in response to the input:
loading a JSON extension file defining additional controls for the GUI;
populating the GUI with the additional controls;
analyzing the JSON extension file to determine event handlers defined for the additional controls; and
setting up the event handlers for the additional controls;
detecting additional user input pertaining to the additional controls via the event handlers; and
performing an action at the GUI indicated by the triggered event handler.

16. The medium of claim 15 wherein:
each event handler is defined in the JSON extension file within a JSON object that includes custom JSON properties.

17. The medium of claim 16 wherein:
the custom JSON properties include a custom JSON property indicating an event to listen for, and a custom JSON property indicating an action to perform in response to the event.

18. The medium of claim 15 wherein the method further comprises:
performing the action at the GUI comprises loading another JSON extension file defining further controls for the GUI.

19. The medium of claim 15 wherein:
the GUI is implemented as a JavaScript GUI.

20. The medium of claim 15 wherein the method further comprises:
setting up the event handlers by setting up subroutines that monitor input from a user interface.
